(19) United States
(12) Patent Application Publication
(10) Pub. No.: US 2026/0225584 A1
(43) Pub. Date: Aug. 6, 2026

(54) INFORMATION PROCESSING APPARATUS, INFORMATION PROCESSING METHOD, AND PARKING ASSISTANCE SYSTEM

(71) Applicant: SONY SEMICONDUCTOR SOLUTIONS CORPORATION, KANAGAWA (JP)

(72) Inventor: MORIHIRO MIZUTANI, KANAGAWA (JP)

(21) Appl. No.: 19/152,336

(22) PCT Filed: Dec. 25, 2023
(86) PCT No.: PCT/JP2023/046316

§ 371 Date: Jul. 30, 2025

(30) Foreign Application Priority Data
Feb. 14, 2023 (JP) 2023-021099

(51) Int. Cl. B60W 30/06; B60W 60/00; G01S 17/931; G06T 7/10; G06T 7/70; G06V 10/764; G06V 20/58

(52) U.S. Cl. CPC B60W 30/06; B60W 60/001; G01S 17/931; G06T 7/10; G06T 7/70; G06V 10/764; G06V 20/58; B60W 2554/20; G06T 2207/10028

(57) ABSTRACT

An information processing apparatus according to an embodiment of the present technology includes a sensing information acquiring section, a class information generator, a stationary object detector, and a position information calculator. The sensing information acquiring section acquires sensing information based on a sensor included in a vehicle. The class information generator generates class information for an object included in the sensing information. The stationary object detector detects a stationary object from among the objects on the basis of the class information, the stationary object moving with a probability less than or equal to a specified threshold. The position information calculator calculates position information regarding a position of the vehicle on the basis of comparison of position information regarding a position of the stationary object to stored map information.

### TECHNICAL FIELD

The present technology relates to an information processing apparatus, an information processing method, and a parking assistance system that can be applied to, for example, self-position estimation.

### BACKGROUND ART

Patent Literature 1 discloses an in-vehicle processing apparatus that estimates a position of a vehicle in a first coordinate system on the basis of group-of-points data, local surrounding information, and an environmental condition, the group-of-points data representing a portion of an object around the vehicle in the first coordinate system, the local surrounding information representing a position of the vehicle and the portion of the object in a second coordinate system.

This results in achieving position estimation resistant to disturbances (for example, paragraphs [0059] to [0064] of the specification and FIG. 6 in Patent Literature 1).

### CITATION LIST

### Patent Literature

Patent Literature 1: Japanese Patent Application Laid-open No. 2020-34366

### DISCLOSURE OF INVENTION

### Technical Problem

With respect to self-position estimation performed when there is a change in an environment around a vehicle, there is a need for a technology that makes it possible to perform self-position estimation with a higher degree of accuracy.

In view of the circumstances described above, it is an object of the present technology to provide an information processing apparatus, an information processing method, and a parking assistance system that make it possible to perform self-position estimation with a higher degree of accuracy.

### Solution to Problem

In order to achieve the object described above, an information processing apparatus according to an embodiment of the present technology includes a sensing information acquiring section, a class information generator, a stationary object detector, and a position information calculator.

The sensing information acquiring section acquires sensing information based on a sensor included in a vehicle.

The class information generator generates class information for an object included in the sensing information.

The stationary object detector detects a stationary object from among the objects on the basis of the class information, the stationary object moving with a probability less than or equal to a specified threshold.

The position information calculator calculates position information regarding a position of the vehicle on the basis of comparison of position information regarding a position of the stationary object to stored map information.

In the information processing apparatus, class information is generated for an object included in sensing information based on a sensor included in a vehicle. A stationary object is detected from among the objects on the basis of the class information, the stationary object moving with a probability less than or equal to a specified threshold; and position information regarding a position of the vehicle is calculated on the basis of comparison of position information regarding a position of the stationary object to stored map information. This makes it possible to perform self-position estimation with a higher degree of accuracy.

The sensor may include a camera and LiDAR. In this case, the sensing information may include image data and group-of-points data.

The class information generator may classify the objects into at least one class on the basis of the image data and the group-of-points data.

The information processing apparatus may further include a class filtering section that performs filtering such that the stationary object being from among the objects and detected by the stationary object detector remains.

The filtering may include excluding the group-of-points data of a group of points of the object other than the stationary object.

The class information generator may generate the class information using semantic segmentation.

The position information regarding the position of the stationary object may include group-of-points data that indicates a three-dimensional position of the stationary object. In this case, the map information may include the group-of-points data of a group of points of the object situated at a specified location.

An information processing method according to an embodiment of the present technology is an information processing method that is performed by a computer system, the information processing method including acquiring sensing information based on a sensor included in a vehicle. Class information is generated for an object included in the sensing information. A stationary object is detected from among the objects on the basis of the class information, the stationary object moving with a probability less than or equal to a specified threshold. Position information regarding a position of the vehicle is calculated on the basis of comparison of position information regarding a position of the stationary object to stored map information.

A parking assistance system according to an embodiment of the present technology includes a vehicle, an information processing apparatus, and an automated driving controller.

The information processing apparatus includes a sensing information acquiring section, a class information generator, a stationary object detector, and a position information calculator.

The sensing information acquiring section acquires sensing information based on a sensor included in the vehicle.

The class information generator generates class information for an object included in the sensing information.

The stationary object detector detects a stationary object from among the objects on the basis of the class information, the stationary object moving with a probability less than or equal to a specified threshold.

The position information calculator calculates position information regarding a position of the vehicle on the basis of comparison of position information regarding a position of the stationary object to stored map information.

The automated driving controller includes a behavior planning section and a movement controller.

The behavior planning section creates a traveling route on the basis of position information regarding a position of the vehicle, the traveling route connecting the vehicle and a space in which the vehicle is allowed to be parked.

The movement controller controls the vehicle on the basis of the traveling route.

### BRIEF DESCRIPTION OF DRAWINGS

FIG. 1 is a block diagram of an example of a configuration of an information processing apparatus according to the present technology.

FIG. 2 is a flowchart of a method for estimating a self-position.

FIG. 3 is a block diagram of an example of a configuration of a parking assistance system.

FIG. 4 is a flowchart of mapping.

FIG. 5 is a flowchart of automatic parking.

### MODE(S) FOR CARRYING OUT THE INVENTION

Embodiments according to the present technology will now be described below with reference to the drawings.

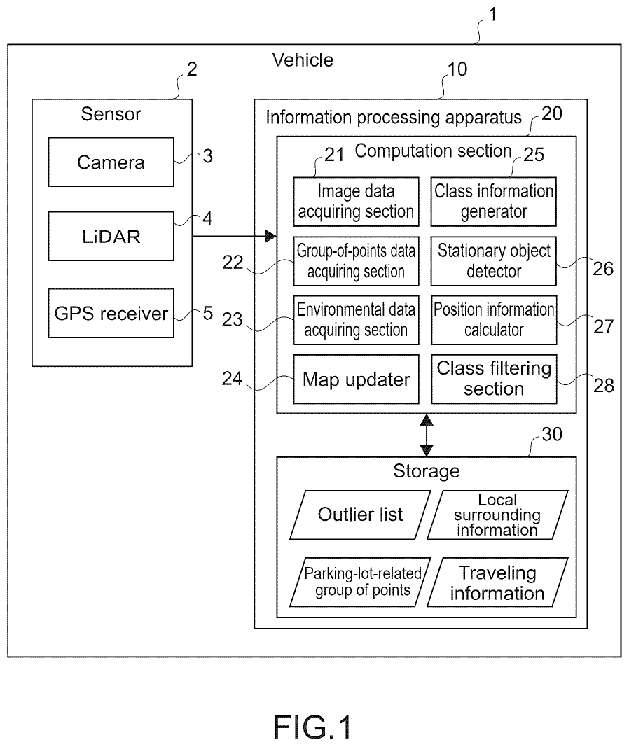

FIG. 1 is a block diagram of an example of a configuration of an information processing apparatus according to the present technology.

As illustrated in FIG. 1, a vehicle 1 includes a sensor 2 and an information processing apparatus 10. In the present embodiment, the information processing apparatus 10 is included in the vehicle 1, and estimates position information regarding a position of the vehicle 1.

The sensor 2 includes a camera 3, light detection and ranging or laser imaging detection and ranging (LiDAR) 4, and a GPS receiver 5. For example, the camera 3 includes an image sensor, and captures an image of a region in a traveling direction of the vehicle 1 and an image of a region in an environment around the vehicle 1. The LiDAR 4 performs detection and distance measurement using light, and acquires a group of points of an object situated around the vehicle 1. The GPS receiver 5 receives signals from a plurality of satellites included in a satellite navigation system, and calculates position information regarding a position (latitude and longitude) of the GPS receiver 5 (the vehicle 1) using computation based on the received signals.

Information acquired by the sensor 2 is supplied to the information processing apparatus 10. Note that the sensor 2 is not limited to having the configuration described above, and may include various radars. Further, any number of sensors 2 that can be actually placed in the vehicle 1 may be acceptable.

The information processing apparatus 10 includes hardware, such as a processor including a CPU, a GPU, and a DSP; a memory including a ROM and a RAM; and a storage device including an HDD, that is necessary for a configuration of a computer. For example, an information processing method according to the present technology is performed by the CPU loading, into the RAM, a program according to the present technology that is recorded in, for example, the ROM in advance and executing the program.

For example, the information processing apparatus 10 can be implemented by any computer such as a PC. Of course, hardware such as an FPGA or an ASIC may be used. In the present embodiment, a position information calculator 27 is implemented as a functional block by the CPU executing a specified program. Of course, dedicated hardware such as an integrated circuit (IC) may be used in order to implement the functional block.

The program is installed on the information processing apparatus 10 through, for example, various recording media. Alternatively, the installation of the program may be performed via, for example, the Internet. In the present embodiment, a program used to execute a parking assistance system 100 described later is stored in the ROM and is deployed by the RAM to be executed by a computation section 20.

The type and the like of a recording medium that records therein a program are not limited, and any computer-readable recording medium may be used. For example, any non-transitory computer-readable recording medium may be used.

As illustrated in FIG. 1, the information processing apparatus 10 includes a computation section 20 and a storage 30. The computation section 20 includes an image data acquiring section 21, a group-of-points data acquiring section 22, an environmental data acquiring section 23, a map updater 24, a class information generator 25, a stationary object detector 26, a position information calculator 27, and a class filtering section 28.

The image data acquiring section 21 acquires image data acquired from the camera. For example, the image data includes data of images of objects, such as another vehicle and a person, that move (hereinafter referred to as moving objects), and data of images of objects, such as a dividing line and a parking block in a parking lot, that are less likely to move or to be moved (hereinafter referred to as stationary objects). In the present embodiment, the acquired image data is supplied to the class information generator.

The group-of-points data acquiring section 22 acquires group-of-points data acquired from the LiDAR. The group-of-points data includes position information regarding a position of a group of points that represents a portion of an object. For example, coordinates of a group of points as well as latitude and longitude are acquired as the group-of-points data, where the coordinates of the group of points are obtained when a traveling direction of the vehicle 1 is set to be an X axis and a rightward direction of the vehicle 1 is set to be a Y axis, with the vehicle 1 (the LiDAR) being a reference (an origin (0,0) ). Typically, the groups of points are given to various moving objects and stationary objects such as other vehicles situated in parking lots (in respective parking spaces) and around the vehicle 1, trees, traffic lights, traffic signs, and people.

In the present embodiment, the group-of-points data includes a parking-lot-related group of points and a surrounding-information-related group of points, where the parking-lot-related group of points includes position information regarding a parking lot, and the surrounding-information-related group of points includes position information regarding a position of an object such as a landmark that serves as a guide to a specified location.

The parking-lot-related group of points includes a position of a parking lot and coordinates of a parking space. For example, the position of a parking lot refers to latitude and longitude of each of an entrance and an exit of the parking lot. Further, the coordinates of a parking space refer to coordinates of four corners of a parking region when the parking region is rectangular. In the present embodiment, the parking-lot-related group of points is acquired upon mapping described later. Further, the parking-lot-related group of points may be associated with environmental data obtained when the parking-lot-related group of points is recorded. In other words, weather, a season, a temperature, and the like when the parking-lot-related group of points is recorded may be recorded.

Note that the parking-lot-related group of points may be prerecorded for each group of parking lots. For example, a parking-lot-related group of points of a parking lot frequently used by a user may be recorded by the user, or a parking-lot-related group of points of a parking lot around the vehicle 1 may be recorded on the basis of position information regarding a position of the vehicle 1.

The surrounding-information-related group of points refers to coordinates of a group of points given to a landmark arranged inside or outside of a parking lot. For example, with respect to the surrounding-information-related group of points, a group of points given to a landmark in a captured image acquired from the camera is extracted from a group of points acquired from the LiDAR, on the basis of the landmark.

The environmental data acquiring section 23 acquires environmental data that indicates an environment around the vehicle 1. The environmental data includes various pieces of data of, for example, weather, a temperature, and a time that affect a sensor. For example, due to an environmental difference in, for example, shadow or brightness, it may be difficult to perform a matching of pieces of image data acquired at the same place but respectively in the daytime and at night. Likewise, the matching is difficult due to various environmental changes such as environmental changes due to summer and winter, and environmental changes due to rainy weather and fine weather. In other words, the environmental data can also be data that affects the accuracy in matching pieces of image data or groups of points.

In the present embodiment, the environmental data includes environmental data of an environment around the vehicle 1 and environmental data of an environment in a parking lot. For example, the environmental data of an environment around the vehicle 1 is environmental data when the vehicle 1 is being driven (operated) by a user (current environmental data). Further, the environmental data of an environment in a parking lot is environmental data when a prerecorded parking-lot-related group of points of a parking lot is recorded (past environmental data).

Note that, in the present embodiment, position information regarding a position of the vehicle 1 that is acquired by the GPS receiver 5, image data, group-of-points data, and environmental data correspond to sensing information based on a sensor included in the vehicle 1. The position information regarding a position of the vehicle 1 that is acquired by the GPS receiver 5, the image data, the group-of-points data, and the environmental data may be hereinafter referred to as sensing information.

The map updater 24 updates a map of a region around the vehicle 1. For example, the map updater 24 updates a map in a current frame on the basis of image data, group-of-points data, and environmental data that are acquired for each frame. In the present embodiment, three-dimensional transformation is performed on the acquired group-of-points data, and a three-dimensional map made up of a group of points using the moving vehicle 1 as a reference is updated. The three-dimensional map made up of a group of points may be hereinafter referred to as group-of-points-map information.

Note that a method for updating a map is not limited. For example, existing map information may be acquired on the basis of position information regarding a position of the vehicle 1, and sensing information in a current frame may be added to the acquired map information to update a map.

The class information generator 25 generates class information regarding a class of each object using sensing information. In the present embodiment, the class information generator 25 uses image data and group-of-points data in combination to generate various class information regarding classes of, for example, a parked automobile, a person, and a building with respect to objects situated around the vehicle 1. For example, the class information generator 25 classifies respective objects into classes using 3D semantic segmentation.

Here, when, for example, only image data is used, a feature point is not easily secured, and how objects look differs depending on an environmental change due to, for example, time, a season, or a weather. Further, when only group-of-points data is used, a class or a context of an object is not easily recognized, and calculation costs are increased.

In the present embodiment, the use of image data and group-of-points data in combination makes it possible to acquire a group of densely situated points using the LiDAR. This results in increasing the number of groups of points, and thus in improving the accuracy in matching groups of points. Further, not a pixel value of an image but an object is recognized as a class, and distance information regarding a distance measured by the LiDAR is resistant to an environmental change. Thus, how objects look remains unchanged despite various environmental changes. This makes it possible to improve the accuracy.

On the basis of class information, the stationary object detector 26 detects a stationary object, from among objects, that moves with a probability less than or equal to a specified threshold. For example, the stationary object detector 26 determines whether an object is a moving object or a stationary object using class information regarding classes of respective objects on the basis of a preset table, and detects a stationary object from among the respective objects.

Note that the detection method is not limited thereto, and a stationary object may be detected using machine learning. Further, for example, it may be determined whether an object has moved, using an amount of movement of the object for each frame (for example, the same group of points or pixel value is moved by 10 cm for each frame).

The position information calculator 27 calculates position information regarding a position of the vehicle 1 on the basis of comparison of position information regarding a position of a stationary object to stored map information. In the present embodiment, a matching of coordinates of a group of points of a stationary object and coordinates of each object that are included in map information is performed to calculate position information regarding a position of the vehicle 1. The position information regarding a position of the vehicle 1 is hereinafter referred to as a self-position. Note that the self-position includes latitude and longitude.

The map information includes position information regarding a position of a specified location (for example, latitude and longitude) and group-of-points data of a group of points of an object situated at the specified location. For example, the map information includes groups of points given to various objects such as buildings for, for example, landmarks, lanes, streets, traffic signs, and parking blocks. In other words, the map information includes position information regarding positions of objects. In the present embodiment, a parking lot is an example of the specified location. Without being limited thereto, pieces of map information regarding maps of various locations may be used.

The class filtering section 28 performs filtering on the basis of class information regarding a class of each object. For example, a moving object such as an automobile or person that is more likely to move, and an object such as a shrubbery or tree that is more likely to be changed are classified into pieces of class information using semantic segmentation, and filtering is performed on the basis of the class information. In other words, an object, such as an object that is more likely to move or an object of which a form is more likely to be changed according to the season, that has a bad effect on a matching of groups of points is excluded by filtering.

In the present embodiment, as a result of the filtering, an object of which a class belongs to a stationary object remains, and an object of which a class belongs to a moving object is excluded. For example, group-of-points data of a group of points given to a moving object is excluded in order not to affect the matching.

Accordingly, a point that has a bad effect on matching can be excluded by generating class information from a group of points. In other words, a group of points of a moving object changed between mapping described later and relocation or between the relocations is excluded, the relocation being performed to specify the traveling vehicle 1 on a map; and a surrounding environment (environmental data) such as a shrubbery that differs depending on, for example, a season is further excluded. This makes it possible to improve the accuracy. Further, filtering is performed on class information to reduce the number of points included in a group of points of a moving object. This makes it possible to reduce calculation costs.

The storage 30 includes a RAM that is a readable and writable storage area, and a nonvolatile storage apparatus. In the present embodiment, the storage 30 stores therein an outlier list, a surrounding-information-related group of points, a parking-lot-related group of points, and traveling information. Note that which of the pieces of data is recorded in a RAM or a nonvolatile storage apparatus is not limited.

For example, the outlier list stores therein a surrounding-information-related group of points that is set to be a non-processing target and all of the held group-of-points-map information. Note that the outlier list may be updated as appropriate.

The traveling information includes a traveling trajectory of the vehicle 1 upon mapping described later. For example, with respect to the traveling information, latitude and longitude that are acquired from the GPS receiver 5 are stored as the traveling trajectory of the vehicle 1.

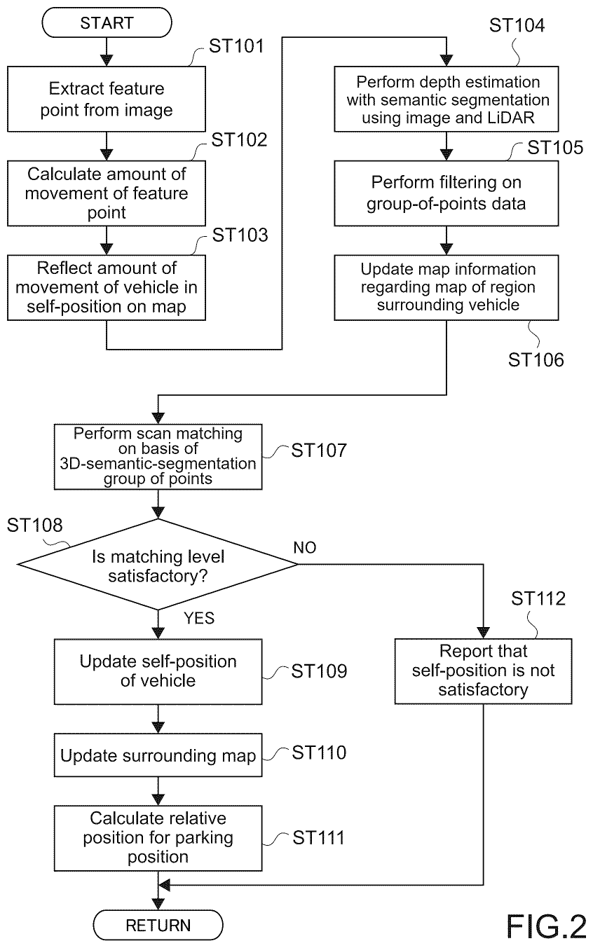

FIG. 2 is a flowchart of a method for estimating a self-position. Note that the case in which the vehicle 1 is traveling is described in FIG. 2 as an example.

As illustrated in FIG. 2, the position information calculator 27 extracts a feature point from image data of an image captured by the camera (a captured image) (Step 101). Further, a captured image is captured using the camera for each frame, and an amount of movement of the feature point is calculated, the movement amount being obtained using the feature point extracted from a previous frame and the feature point extracted from a current frame (Step 102). The calculated amount of movement is reflected in a self-position on a map on the basis of the amount of movement (Step 103). In the present embodiment, the processes of Steps 101 to 103 described above are performed using visual simultaneous localization and mapping (V-SLAM).

The class information generator 25 generates class information regarding classes of respective objects using image data and group-of-points data, and performs depth estimation to estimate a distance from the camera to each of the objects by analyzing a two-dimensional video or image (Step 104). In the present embodiment, the class information generator 25 associates class information with each pixel of image data in one frame using 3D semantic segmentation. For example, classification is performed into a building, a roadway, and a parking space, and, for example, class regions such as a region of the building and a region of the roadway are determined in the image data. In other words, the class information includes classes of respective objects and regions of the objects (position information).

On the basis of the class information generated in Step 104, the stationary object detector 26 detects a stationary object, from among the objects, that moves with a probability less than or equal to a specified threshold. Further, the class filtering section 28 causes the detected stationary object to remain, and excludes group-of-points data given to a moving object (Step 105).

On the basis of pieces of class information obtained by the classification performed using 3D semantic segmentation, and depth data acquired by depth estimation for each pixel of the image data, the map updater 24 updates group-of-points-map information regarding a group-of-points map of a region surrounding the vehicle 1 (Step 106).

The position information calculator 27 performs a scan matching of updated group-of-points-map information and prestored map information (Step 107). In the present embodiment, the scan matching is performed on the basis of the class information regarding a class of an object and 3D-semantic-segmentation group of points based on the group-of-points data, the class information being generated by the class information generator 25.

Further, it is determined whether a level of the matching described above is satisfactory (Step 108). Note that the matching method is not limited, and the matching level may be quantified to perform determination. For example, the level of matching of each of the acquired 3D-semantic-segmentation groups of points and a group of points on a map may be defined as a score, and calculation may be performed for all of the groups of points.

When the matching level is satisfactory (YES in Step 108), the self-position is updated (Step 109). Further, the map updater 24 updates a surrounding map of a region around the vehicle 1 (Step 110). Furthermore, a relative position for a position at which the vehicle 1 can be parked, with the self-position being a reference, is calculated on the basis of the self-position and the surrounding map (Step 111). When the matching level is not satisfactory (NO in Step 108), it is reported to a user that the self-position is not satisfactory (Step 112).

In the present embodiment, SLAM (matching of groups of points) is performed using groups of points in Steps 108 to 111, as described above. In other words, a self-position of the vehicle 1 is estimated using V-SLAM, 3D semantic segmentation, and a matching of groups of points in combination in the flowchart in FIG. 2.

When, for example, only V-SLAM is used, there are only a small number of feature points, and a degree of accuracy is lower, compared to a matching of groups of points. Further, a pixel or brightness in an image is easily changed due to, for example, backlight or noise at night. On the other hand, when only a matching of groups of points is used, this results in high calculation costs. Further, a resolution of a group of points is low in the vertical direction, and this results in difficulty in dealing with a change in a pose of the vehicle 1 successfully.

In the present embodiment, an amount of movement is calculated roughly using V-SLAM, and precision work that SLAM is not good at can be complemented using a matching of groups of points. Further, an amount of calculation can be reduced since the matching is performed on the basis of the amount of movement obtained using V-SLAM. Furthermore, the use of a pose change obtained using V-SLAM makes it possible to improve the accuracy.

As described above, in the information processing apparatus 10 according to the present embodiment, class information is generated for an object included in sensing information based on the sensor 2 included in the vehicle 1. On the basis of the class information, a stationary object that moves with a probability less than or equal to a specified threshold is detected from among objects. Position information regarding a position of the vehicle 1 is calculated on the basis of comparison of position information regarding a position of the stationary object to stored map information. This makes it possible to perform self-position estimation with a higher degree of accuracy.

Conventionally, when information regarding a surrounding environment is acquired only using a camera, this results in difficulty in dealing with an environmental change caused due to shadow, fallen objects such as fallen leaves, movement of a surrounding obstacle, an inclination of a road surface, and weather. This results in difficulty in performing a matching of a current position and a stored surrounding environment map correctly. Further, when automated driving is performed on the basis of the pieces of information described above, there are problems with, for example, an error or accuracy of a three-dimensional object, only a certain direction for driving forward, a shift of an own vehicle in a Y-axis direction, dashed lines in a center portion of a road and in a shoulder of a road, recognition of a cycle pattern of, for example, a parking slot, lack of landmarks, and lack of robustness against a change in traveling route between a memory and IPA.

In the present technology, image data and group-of-points data are input to a neural network to create three-dimensional semantic segmentation including class information for each region. Further, self-position estimation is performed using the class information on the basis of an object that is less likely to move. This makes it possible to three-dimensionally grasp a region around a vehicle, to grasp a positional relationship between a vehicle and an object around the vehicle, and to grasp the context, and thus to improve the accuracy in self-position estimation.

### EXAMPLES

Here, examples that use the information processing apparatus 10 above are described. In the following examples, the information processing apparatus 10 is used for self-position estimation performed by the parking assistance system 100 in the vehicle 1. Note that descriptions of a configuration and an operation that are similar to those of the sensor 2 and information processing apparatus 10 described above are omitted or simplified.

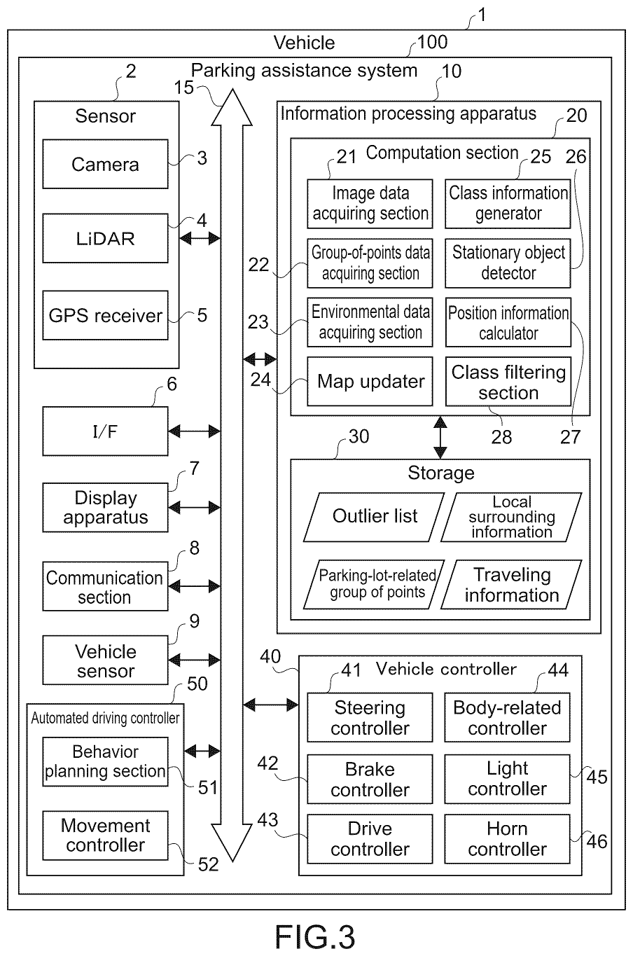

FIG. 3 is a block diagram of an example of a configuration of the parking assistance system 100.

As illustrated in FIG. 3, the parking assistance system 100 is included in the vehicle 1, and includes an I/F 6, a display apparatus 7, a communication section 8, a vehicle sensor 9, a vehicle controller 40, and an automated driving controller 50 in addition to the sensor 2 and the information processing apparatus 10.

The sensor 2, the information processing apparatus 10, the I/F 6, the display apparatus 7, the communication section 8, the vehicle sensor 9, the vehicle controller 40, and the automated driving controller 50 are communicably connected to each other through a communication network 15.

For example, the communication network 15 includes, for example, an in-vehicle communication network or bus that is compliant with digital bidirectional communication standards, where examples of the communication network 15 include a controller area network (CAN), a local interconnect network (LIN), a local area network (LAN), FlexRay (registered trademark), and Ethernet (registered trademark). The examples of the communication network 15 may be selectively used depending on the type of data to be transmitted. For example, CAN may be applied to data related to vehicle control, and Ethernet may be applied to large volumes of data. Note that structural elements of the parking assistance system 100 may be directly connected to each other without using the communication network 15, but using wireless communication, such as near field communication (NFC) or Bluetooth (registered trademark), that is provided on the assumption of communication at a relatively short distance.

The parking assistance system 100 is a system used to perform driving automation of the vehicle 1 going to a specified parking space in a parking lot to stop in the specified parking space. The driving automation includes driving automation and driving assistance from Level 1 to Level 5, as well as remote driving and remote assistance of the vehicle 1 that are performed by a remote driver.

Parking of the vehicle 1 that is performed by automated driving being adopted using the parking assistance system 100 may be hereinafter referred to as automatic parking.

The I/F 6 performs communication of information with the information processing apparatus 10 and another apparatus included in the parking assistance system 100.

The display apparatus 7 is a display device in which, for example, liquid crystal or EL is used. For example, a graphical user interface (GUI) used to operate the parking assistance system 100 is displayed on the display apparatus 7, and the display apparatus 7 is also used as an input apparatus such as a touchscreen. For example, a recording start button used to start the mapping described above, a recording completion button used to complete the mapping described above, and a button used to perform automatic parking are displayed on the display apparatus 7.

Note that, in addition to the display apparatus 7, an input apparatus used to input operation may be included. For example, a keyboard or a button may be included, or a system that enables sound recognition and a microphone used to collect sound may be included.

The communication section 8 is used to perform wireless communication of information between an apparatus external to the vehicle 1 and each of the information processing apparatus 10 and a driving controller. When, for example, a user is outside of the vehicle 1, the parking assistance system 100 may be operated through, for example, a mobile terminal. Further, a parking-lot-related group of points, in a parking lot, that is acquired upon performing automatic parking may be transmitted to another vehicle 1 or a cloud.

The vehicle sensor 9 includes various sensors used to detect a state of the vehicle 1, and supplies the structural elements of the parking assistance system 100 with pieces of sensor data from the respective sensors. With respect to the types and the numbers of the various sensors, any types and any numbers of sensors that can be actually placed in the vehicle 1 may be included in the vehicle sensor 9.

For example, the vehicle sensor 9 includes a speed sensor, an acceleration sensor, an angular velocity sensor (a gyroscope), and an inertial measurement unit (IMU) obtained by combining these sensors. For example, the vehicle sensor 9 includes a steering angle sensor that detects a steering angle of a steering wheel, a yaw rate sensor, an accelerator sensor that detects an amount of operation of a gas pedal, and a brake sensor that detects an amount of operation of a brake pedal. For example, the vehicle sensor 9 includes a rotation sensor that detects a rotation speed of an engine or a motor, an air pressure sensor that detects a tire pressure, a slip ratio sensor that detects a slip ratio of a tire, and a wheel speed sensor that detects a rotation speed of a wheel. For example, the vehicle sensor 9 includes a battery sensor that detects a remaining battery life and a temperature of a battery, and an impact sensor that detects an impact imposed from the outside.

The vehicle controller 40 controls respective structural elements of the vehicle 1. The vehicle controller 40 includes a steering controller 41, a brake controller 42, a drive controller 43, a body-related controller 44, a light controller 45, and a horn controller 46.

For example, the steering controller 41 detects and controls a state of a steering system of the vehicle 1. The steering system includes, for example, a steering mechanism including, for example, a steering wheel, and electric power steering. The steering controller 41 includes, for example, a steering ECU that controls the steering system, and an actuator that drives the steering system.

For example, the brake controller 42 detects and controls a state of a brake system of the vehicle 1. The brake system includes, for example, a brake mechanism including, for example, a brake pedal, an antilock brake system (ABS), and a regenerative brake mechanism. The brake controller 42 includes, for example, a brake ECU that controls the brake system, and an actuator that drives the brake system.

For example, the drive controller 43 detects and controls a state of a drive system of the vehicle 1. The drive system includes, for example, a gas pedal, a driving force generating apparatus used to generate driving force for, for example, an internal combustion engine or a driving motor, and a driving force transmitting mechanism used to transmit the driving force to wheels. The drive controller 43 includes, for example, a drive ECU that controls the drive system, and an actuator that drives the drive system.

For example, the body-related controller 44 detects and controls a state of a body-related system of the vehicle 1. The body-related system includes, for example, a keyless entry system, a smart key system, a power window apparatus, a power seat, an air conditioner, an airbag, a seat belt, and a shift lever. The body-related controller 44 includes, for example, a body-related ECU that controls the body-related system, and an actuator that drives the body-related system.

For example, the light controller 45 detects and controls states of various lights of the vehicle 1. Examples of a conceivable control-target light include a headlight, a backup light, a fog light, a turn signal, a stoplight, projection, and display of a bumper. The light controller 45 includes, for example, a light ECU that controls the lights, and an actuator that drives the lights.

For example, the horn controller 46 detects and controls a state of a car horn of the vehicle 1. The horn controller 46 includes, for example, a horn ECU that controls the car horn, and an actuator that drives the car horn.

The automated driving controller 50 includes a behavior planning section 51 and a movement controller 52. The behavior planning section 51 creates a traveling route of the vehicle 1. In the present embodiment, the behavior planning section 51 creates the traveling route connecting the vehicle and a parking space, on the basis of the self-position. The traveling route includes a trajectory along which the vehicle 1 moves (consecutive pieces of position information regarding a position of the vehicle 1), and vehicle control information such as a speed and an angular velocity of the vehicle 1 when traveling along the trajectory.

The movement controller 52 controls the vehicle 1 on the basis of a traveling route. For example, the movement controller 52 controls the steering controller 41, the brake controller 42, and the drive controller 43 to control lateral and longitudinal motions of the vehicle such that the vehicle travels along a route calculated using the traveling route. For example, the movement controller 52 performs control intended to implement a driver assistance function including collision avoidance or shock mitigation, traveling while maintaining a certain distance to a vehicle ahead, traveling while maintaining a vehicle speed, a warning of collision of an own automobile, and a warning of deviation of the own automobile from a lane, or performs control intended to achieve automated driving such as traveling without an operation performed by a driver or a remote driver.

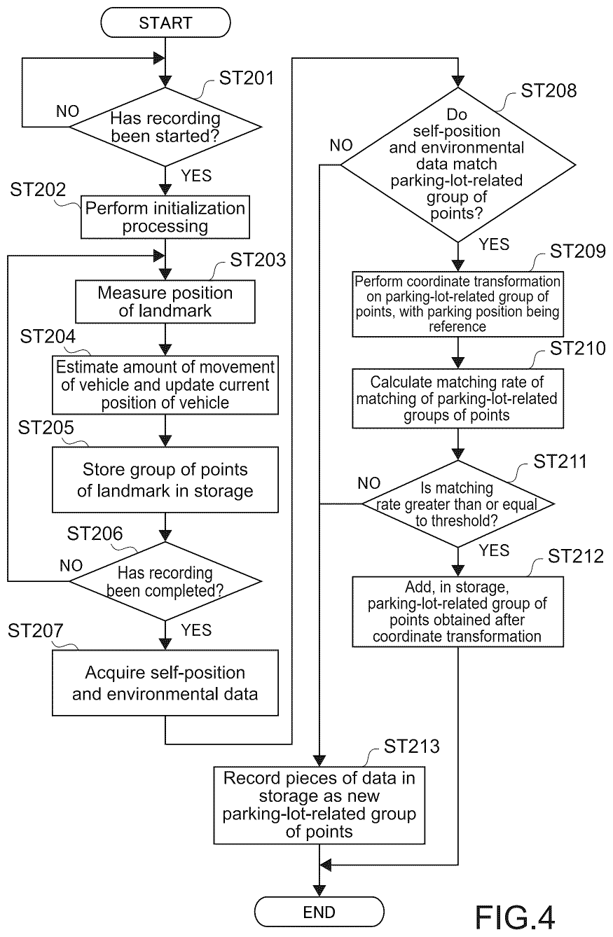

FIG. 4 is a flowchart of mapping. An example of mapping performed from the vehicle 1 entering a parking lot to the vehicle 1 being parked is described below.

In a mapping procedure, for example, a map is created by a user performing an operation of starting recording. For example, the display apparatus 7 on which a mapping-related GUI is displayed is included in the vehicle 1, and the GUI is operated to start recording a parking-lot-related group of points (YES in Step 201).

In the present embodiment, a timing of starting recording is a timing at which the vehicle 1 enters a parking lot. Further, a timing of completing recording is a timing at which the vehicle 1 is parked at a specified location in the parking lot.

Further, when recording is started, a new storage area is secured in a RAM of the storage 30, and a surrounding-information-related group of points and a current position of the vehicle 1 that are stored in advance are initialized (Step 202).

A position of a landmark around the vehicle 1 is measured on the basis of sensing information (Step 203). For example, a surrounding-information-related group of points that is a group of points making up the landmark is extracted on the basis of a captured image acquired using the camera 3 and a group of points acquired from the LiDAR 4. Accordingly, the position is measured.

An amount of movement of the vehicle 1 is estimated, and the current position of the vehicle 1 is updated (Step 204). For example, the amount of movement of the vehicle 1 may be estimated by comparing a previous frame and a current frame using the captured images captured using the camera 3. Moreover, the amount of movement may be estimated using, for example, the GPS receiver 5, the number of rotation of a tire, the speed of the vehicle 1, and a positional relationship with another object.

Group-of-points data of a group of points of the landmark of which a position is measured in Step 203 is stored in the storage 30, the group-of-points data being based on the current position of the vehicle 1 (Step 205). Coordinates of a group of points of the landmark are obtained, with the position of the vehicle 1 being a reference. There is a need to record the group of points of the landmark every time recording is started since the position and a pose (a traveling direction) of the vehicle 1 each differ depending on the timing of starting recording.

Here, the user determines, through the GUI or the like, whether the recording has been completed (Step 206). When the recording has not been completed yet (NO in Step 206), the process returns to Step 203, and the position of the landmark is measured again. When the recording has been completed (YES in Step 206), the GPS receiver 5 acquires the self-position, and the environmental data acquiring section 23 acquires environmental data obtained at the moment of the completion of the recording (Step 207). The acquired self-position and environmental data are recorded in the RAM of the storage 30. Note that the recorded data is not limited to the self-position, and, for example, coordinates of the four corners of the vehicle 1 (coordinates of a parking space) may be recorded according to the size of the vehicle 1.

It is determined whether the self-position and environmental data recorded in Step 207 match a prerecorded parking-lot-related group of points (Step 208). For example, it is determined whether the self-position substantially matches latitude and longitude of a parking lot, or it is determined whether the environmental data recorded in Step 207 substantially matches environmental data obtained at a timing of acquiring the recorded parking-lot-related group of points. Note that a threshold used to determine that the pieces of data match may be set discretionarily. In the case of, for example, a parking lot, it may be determined that the pieces of data substantially match despite an error of, for example, from 10 m to 100 m that is set on the basis of a size of the parking lot. Further, in the case of, for example, environmental data, it may be considered that environmental data of an environment at a temperature of 5° C. substantially matches environmental data of an environment at a temperature of 10° C.

When the self-position and the environmental data match the prerecorded parking-lot-related group of points (YES in Step 208), coordinates of the parking-lot-related group of points stored in the storage 30 are transformed into a coordinate system using a parking position of the vehicle 1 (the self-position when the vehicle 1 is parked) as a reference (Step 209). Further, a matching rate of matching of the parking-lot-related group of points in the coordinate system after the transformation and the prerecorded parking-lot-related group of points is calculated (Step 210).

It is determined whether the calculated matching rate is greater than or equal to a threshold (Step 211). When, for example, the number of groups of points matched is greater than or equal to a threshold (YES in Step 211), it is determined that a parking lot in which the vehicle 1 is currently parked is a recorded parking lot. Further, after the determination, a parking-lot-related group of points obtained after the transformation in Step 209 is added to the parking-lot-related group of points prerecorded in the storage 30 (Step 212). In other words, merger processing is performed.

When the self-position and the environmental data do not match the prerecorded parking-lot-related group of points (NO in Step 208), or when the number of groups of points matched is less than or equal to the threshold (NO in Step 211), the group-of-points data, environmental data, self-position upon starting of recording, and self-position upon completion of the recording (parking position) acquired in Steps 201 to 207 are stored in the storage 30 as new parking-lot-related groups of points (Step 213).

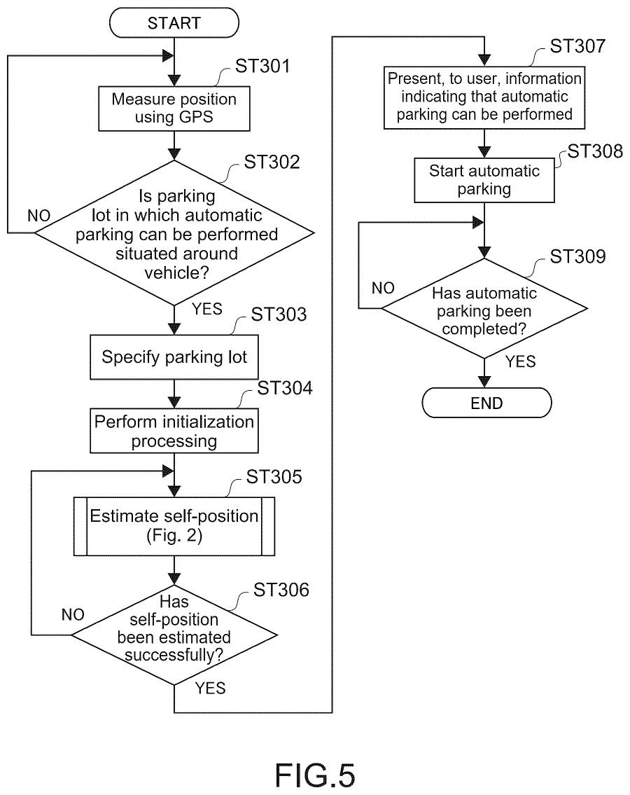

FIG. 5 is a flowchart of automatic parking. In FIG. 5, a parking-lot-related group of points of a specific parking lot is recorded in the storage 30 after the mapping in FIG. 4. In other words, the mapping in FIG. 4 has been performed as a preparation performed in advance, and a user causes the vehicle 1 to be automatically parked in the same parking lot.

The GPS receiver 5 measures a current self-position (Step 301). For example, latitude and longitude of the vehicle 1 are acquired.

It is determined whether a recorded parking lot (a parking lot in which automatic parking can be performed) is situated near the vehicle 1 (Step 302). In the present embodiment, it is determined whether the acquired self-position substantially matches latitude and longitude of one of parking lots recorded in the storage 30. When, for example, there is a recorded parking-lot-related group of points (for example, an entrance of the parking lot) within a radius of 100 meters from the self-position set to be a reference, it is determined that there is a parking lot in which automatic parking can be performed. When no parking lot in which automatic parking can be performed is situated near the vehicle 1 (NO in Step 302), the process returns to Step 301.

Note that, when the vehicle 1 is traveling, a period of time used to search for a parking lot in which automatic parking can be performed may be provided. When, for example, there is a recorded parking-lot-related group of points that is situated within a specified distance from the moving vehicle 1 and at which the vehicle 1 arrives within a specified period of time, it may be determined that there is a parking lot in which automatic parking can be performed.

When a parking lot in which automatic parking can be performed is situated near the vehicle 1 (YES in Step 302), a parking lot that substantially matches the current self-position is specified using a parking-lot-related group of points recorded in the storage 30 (Step 303). Further, after the parking lot is specified, a surrounding-information-related group of points and a self-position that are stored in the RAM of the storage 30 are initialized (Step 304). In other words, a coordinate system based on a self-position and a pose of the vehicle 1 that are obtained upon completion of specifying the parking lot is newly set. For example, a traveling direction (a forward direction) of the vehicle 1 is set to be an X axis, with the position of the vehicle 1 being an origin.

Here, the parking assistance system 100 performs self-position estimation (Step 305). The self-position estimation is performed in accordance with the flowchart in FIG. 2, and it is determined whether the self-position has been estimated successfully (Step 306).

When the self-position has been estimated successfully (YES in Step 306), information indicating that automatic parking can be performed is presented to the user (Step 307). Note that a method for presenting information is not limited, and a message may be displayed on a display, or the information may be presented using, for example, sound or vibration.

The user starts automatic parking through, for example, a GUI or a button (Step 308). With respect to a procedure of automatic parking, the behavior planning section 51 creates a traveling route from the self-position to a space in which parking can be performed, on the basis of the current position of the vehicle 1. Note that a method for creating the traveling route is not limited, and, for example, global path planning and local path planning may be performed. The global path planning includes processing of roughly planning a route from a start to a goal. The local path planning is also referred to as trajectory planning, and includes processing of creating a trajectory near the vehicle 1 in consideration of motion characteristics of the vehicle 1, where the trajectory enables the vehicle 1 to travel safely and smoothly on the planned route.

Further, the automatic parking includes processing of planning movement to be performed to travel safely and accurately on the created traveling route within a time. For example, the movement controller 52 calculates a target speed for and a target angular velocity for the vehicle 1 to operate the vehicle 1. Further, a speed in consideration of acceleration with which burdens are not imposed on the user and another person in the vehicle 1, a curvature (a radius of curvature) upon turning right or left, or a surrounding person (moving object) may be set.

It is determined whether the vehicle 1 has arrived at a parking position and parking of the vehicle 1 has been completed (Step 309). For example, the user may confirm that the vehicle 1 has been stopped at the parking position and may terminate automatic parking by, for example, pressing a button, or self-position estimation may be performed, and when coordinates of the self-position have matched coordinates of a parking space (the vehicle 1 has arrived at the parking position), it may be determined that the parking has been completed.

When the parking has been completed (YES in Step 309), the parking assistance system 100 is terminated. For example, the termination may be performed by an operation performed by a user, or the termination may be performed automatically when the vehicle 1 is stopped in a parking space.

Further, a traveling route used upon automatic parking and data used to perform vehicle control used to travel along the traveling route may be recorded in the storage 30. In the case of, for example, a parking lot or garage that includes a determined space in which a user is usually parked, the recording may be performed.

The respective configurations of, for example, the class information generator, the stationary object detector, and the position information calculator; the control flow; and the like described with reference to the respective figures are merely embodiments, and any modifications may be made thereto without departing from the spirit of the present technology. In other words, for example, any other configurations or algorithms for purpose of practicing the present technology may be adopted.

Note that the effects described in the present disclosure are not limitative but are merely illustrative, and other effects may be provided. The above description of the plurality of effects does not necessarily mean that the plurality of effects is provided at the same time. The above description means that at least one of the effects described above is provided depending on, for example, a condition. Of course, there is a possibility that an effect that is not described in the present disclosure will be provided.

At least two of the features of the respective embodiments described above can also be combined. In other words, the various features described in the respective embodiments may be combined discretionarily regardless of the embodiments.

Note that the present technology may also take the following configurations.

(1) An information processing apparatus, including:
a sensing information acquiring section that acquires sensing information based on a sensor included in a vehicle;
a class information generator that generates class information for an object included in the sensing information;
a stationary object detector that detects a stationary object from among the objects on the basis of the class information, the stationary object moving with a probability less than or equal to a specified threshold; and
a position information calculator that calculates position information regarding a position of the vehicle on the basis of comparison of position information regarding a position of the stationary object to stored map information.

(2) The information processing apparatus according to (1), in which
the sensor includes a camera and LiDAR, and
the sensing information includes image data and group-of-points data.

(3) The information processing apparatus according to (2), in which
the class information generator classifies the objects into at least one class on the basis of the image data and the group-of-points data.

(4) The information processing apparatus according to (3), further including
a class filtering section that performs filtering such that the stationary object being from among the objects and detected by the stationary object detector remains.

(5) The information processing apparatus according to (4), in which
the filtering includes excluding the group-of-points data of a group of points of the object other than the stationary object.

(6) The information processing apparatus according to (1), in which
the class information generator generates the class information using semantic segmentation.

(7) The information processing apparatus according to (1), in which
the position information regarding the position of the stationary object includes group-of-points data that indicates a three-dimensional position of the stationary object, and
the map information includes the group-of-points data of a group of points of the object situated at a specified location.

(8) An information processing method that is performed by a computer system, the information processing method including:
acquiring sensing information based on a sensor included in a vehicle;
generating class information for an object included in the sensing information;
detecting a stationary object from among the objects on the basis of the class information, the stationary object moving with a probability less than or equal to a specified threshold; and
calculating position information regarding a position of the vehicle on the basis of comparison of position information regarding a position of the stationary object to stored map information.

(9) A parking assistance system, including:
a vehicle;
an information processing apparatus that includes
   a sensing information acquiring section that acquires sensing information based on a sensor included in the vehicle,
   a class information generator that generates class information for an object included in the sensing information,
   a stationary object detector that detects a stationary object from among the objects on the basis of the class information, the stationary object moving with a probability less than or equal to a specified threshold, and
   a position information calculator that calculates position information regarding a position of the vehicle on the basis of comparison of position information regarding a position of the stationary object to stored map information; and
an automated driving controller that includes
   a behavior planning section that creates a traveling route on the basis of position information regarding a position of the vehicle, the traveling route connecting the vehicle and a space in which the vehicle is allowed to be parked, and
   a movement controller that controls the vehicle on the basis of the traveling route.

### REFERENCE SIGNS LIST

1 vehicle
2 sensor
3 camera
4 LiDAR
10 information processing apparatus
25 class information generator
26 stationary object detector
27 position information calculator
28 class filtering section
40 vehicle controller
50 driving controller

1. An information processing apparatus, comprising:
a sensing information acquiring section that acquires sensing information based on a sensor included in a vehicle;
a class information generator that generates class information for an object included in the sensing information;
a stationary object detector that detects a stationary object from among the objects on a basis of the class information, the stationary object moving with a probability less than or equal to a specified threshold; and
a position information calculator that calculates position information regarding a position of the vehicle on a basis of comparison of position information regarding a position of the stationary object to stored map information.

2. The information processing apparatus according to claim 1, wherein
the sensor includes a camera and LiDAR, and
the sensing information includes image data and group-of-points data.

3. The information processing apparatus according to claim 2, wherein
the class information generator classifies the objects into at least one class on a basis of the image data and the group-of-points data.

4. The information processing apparatus according to claim 3, further comprising
a class filtering section that performs filtering such that the stationary object being from among the objects and detected by the stationary object detector remains.

5. The information processing apparatus according to claim 4, wherein
the filtering includes excluding the group-of-points data of a group of points of the object other than the stationary object.

6. The information processing apparatus according to claim 1, wherein
the class information generator generates the class information using semantic segmentation.

7. The information processing apparatus according to claim 1, wherein
the position information regarding the position of the stationary object includes group-of-points data that indicates a three-dimensional position of the stationary object, and
the map information includes the group-of-points data of a group of points of the object situated at a specified location.

8. An information processing method that is performed by a computer system, the information processing method comprising:
acquiring sensing information based on a sensor included in a vehicle;
generating class information for an object included in the sensing information;
detecting a stationary object from among the objects on a basis of the class information, the stationary object moving with a probability less than or equal to a specified threshold; and
calculating position information regarding a position of the vehicle on a basis of comparison of position information regarding a position of the stationary object to stored map information.

9. A parking assistance system, comprising:
a vehicle;
an information processing apparatus that includes
a sensing information acquiring section that acquires sensing information based on a sensor included in the vehicle,
a class information generator that generates class information for an object included in the sensing information,
a stationary object detector that detects a stationary object from among the objects on a basis of the class information, the stationary object moving with a probability less than or equal to a specified threshold, and
a position information calculator that calculates position information regarding a position of the vehicle on a basis of comparison of position information regarding a position of the stationary object to stored map information; and
an automated driving controller that includes
a behavior planning section that creates a traveling route on a basis of position information regarding a position of the vehicle, the traveling route connecting the vehicle and a space in which the vehicle is allowed to be parked, and
a movement controller that controls the vehicle on a basis of the traveling route.
